(19) United States
(12) Patent Application Publication
(10) Pub. No.: US 2023/0325869 A1
(43) Pub. Date: Oct. 12, 2023

(54) Automated Product/Service Vending System and Method

(71) Applicant: BRIDGEWELL INC., Taipei City (TW)

(72) Inventor: Pei Lin CHOU, Taipei (TW)

(21) Appl. No.: 18/193,718

(22) Filed: Mar. 31, 2023

(30) Foreign Application Priority Data
Apr. 8, 2022 (TW) 111113530

(51) Int. Cl. G06Q 30/0207; G06Q 30/0201

(52) U.S. Cl. CPC G06Q 30/0239; G06Q 30/0206

(57) ABSTRACT

An automated product/service vending system and method that offers potential customers a discount price for a particular product/service. A price investigation device searches in a plurality of online shops to obtain a lowest market price for the product/service and an offering device calculates a reduced price that is lower than the lowest market price but is profitable for the operator of the system, according to a predetermined profit value of the product/service.

### TECHNICAL FIELD

The present invention relates to a system and method for automatic sales of products and services, in particular to a computer system that automatically calculates a most competitive offer for a product/service that a potential purchaser intents to buy, responds to the purchaser, and closes the transaction, as well as the offering and transaction methods used therein.

### BACKGROUND OF THE INVENTION

Automated vending systems for products and/or services are known and widely used in online product and/or service transactions. However, the traditional automated vending system for products and/or services does not provide an automatic price negotiation function. In other words, if a buyers sees a price marked on the seller's webpage (user interface) and wants a reduced price, the traditional automated vending system does not provide a way to automatically judge whether a bargaining price offered by a potential buyer is acceptable, or to automatically generate a counter-offer that is different from the bargaining price. On the other hand, although sellers are allowed to propose a bargain on a buyer's auction webpage, the traditional system does not provide a tool for the buyer computer to automatically accept or decline the bargaining price, or to automatically generating a counter-offer. All the following negotiations are conducted manually between buyers and sellers online or offline.

In order to solve this technical problem, many solutions were proposed for the automated vending system of products and/or services to automatically change the offered price of a product/service in response to external inputs, so to successfully close a transaction. Other solutions were proposed to improve the degree of automation of the automated vending system for products and/or services.

US Patent Publication US 2005/044001A1 proposes a “Purchase price protection agent” that accepts at a first website user input of information associated with products and/or services purchased by the user from a supplier. The information includes the selling price of the product and/or service and the product and/or service comes with a guaranteed lowest price. The system determines a price of the product and/or service on a second website, and judges whether the user should get the lowest price guarantee refund, based on the price obtained from the second website, followed by sending a refund notification to the user, if the user deserves a guaranteed refund.

Patent document WO 2020-106325A1 proposes a commission fees adjustment system on a network-based marketplace. A purchase offer for an item for sale including an offer price is received. Upon determining that the offer price is below a listed price, a commission fee reduction value is computed based on a difference between the listed price and the offer price. A reduced commission fee is determined based on the commission fee reduction value and a standard commission fee. Upon determining that the reduced commission fee satisfies a condition defined by a set of rules, a transaction for the sale of the item is automatically completed based on the reduced commission fee, by reducing the listed price by the commission fee reduction value.

Patent document WO 2004-008267A2 proposes an agent-controlled commission system in which agents establish their own prices for goods and services and a principal pays commissions automatically based on the agent-established prices. The principal operates a server for the purpose of evaluating purchases, determining commissions, and processing orders. Agents sell goods and services via tailored Internet sites, and adjust their prices independently. The principal pays the applicable commissions for each agent based upon their separately-established pricing.

Patent Publication US 2007/0055568A1 discloses an online real-time price discounting system and method that enable merchants to sell items to different buyers at different prices. The system accepts the selling price of products on competitor websites provided by buyers, calculates the applicable discount price based on the selling price, and provides the buyer with a discount on the selling price. The method also includes the step of making an inquiry to a competitor's website.

From the above description of the prior art, it can be known that selling product/services through the Internet can save a lot of manpower. However, traditional technology does not provide an effective mechanism for price negotiations, so that many opportunities of successful business are lost. Although many have tried to propose an “automated” price negotiation function, the degree of automation is still unsatisfactory. The state of the art is still at the level of technology where a counter-offer is made by the buyer or customer manually. The conventional bargaining method is quite passive; It does not actively offer a lower price from the seller side in order to encourage more buyers to buy. In addition, the conventional technology lacks technical means to automatically calculate a competitive selling price. Even in the case where a vending system allows the buyer to offer a price reduction, there is no tool to counter offer a price that can attract the buyer and simultaneously gives the system operator with possibly highest profits.

### OBJECTIVES OF THE INVENTION

The objective of the present invention is to provide a novel automated product/service vending system, which can automatically calculate and offer to potential buyers an attractive price or discount.

The objective of this invention is also to provide a novel automated product/service vending system, which can automatically calculate a profit-making price lower than the general market price for a product/service, and actively propose it to potential buyers or customers.

Another objective of the present invention is to provide a novel automated product/service vending system, which utilizes the market price information to automatically calculate a profitable price for various products/services that is lower than the market price.

Another objective of the present invention is to provide a novel vending method for products and services, which can be implemented in a computer system to automatically calculate attractive, competitive selling prices or discounts for various products/services. Preferably, the price so obtained is lower than the market price and is profitable to the system operator.

Another objective of the present invention is also to provide an automated price offering method for product and service that utilizes the market price information, to automatically calculate prices that are lower than the market price but is profitable for the system operator.

### SUMMARY OF THE INVENTION

The present invention proposes a system and method for automated vending of products and services. The automated product and service vending system of the present invention is used to sell various products and services via the Internet.

Selling products and services on the Internet is preferred, because it can utilize the strong computing power of computers to “automatically” close transactions. However, there is still difference in the level of automation, which can be determined by the number of steps that requires manual intervention from sellers and buyers. The more steps that require human intervention, the lower level of automation it is. It can be seen from the observation of the prior art that, if a discount can be offered for the selling price of a product/service, the chance of transaction can usually go higher. Therefore, if an appropriate discount can be automatically calculated by the computer system, the transaction process will not need to be discontinued, pending the determination of the seller or the buyer. In addition, a system that can automatically determine an attractive discount would make a deal easier to close. However, how to propose an attractive price, especially a price lower than the market price, while making the seller profitable, is the key to achieving the above goals.

Based on the above background information, the present invention proposes a mechanism for automatically calculating a discount price for a product/service, according to price information of the online commerce market. The discount price includes a profit-making price that is lower than the market price, especially a profit-making price below the lowest known market price. The invention can automatically determine a suitable discount without the need of waiting for the buyer or the seller to respond to a discount request.

The inventors have discovered that in the product/service agent system, those who sell or promote products or services for another will receive compensation. Sometimes this compensation exists in the form of price difference, and sometimes it exists in the form of advertising fees. There are also many other forms of remuneration. A selling agent would be willing to share a part of his/her compensation to the customer in exchange of the customer's willingness to buy. Although the compensation per transaction may shrink, as long as the number of buyers increases, the total profits of the selling agent would increase.

Although the present invention does not need to be limited by any theory, the above observations have inspired the inventors. From the perspective of sharing profits with customers, the invention uses the computer network system to automatically calculate highly attractive discount schemes, and actively proposes offers to potential customers to win transactions. There is no need for customers to ask for discounts. And the calculated discount scheme can make the system operator maintain the highest profit.

The present invention provides a novel product and service vending system. The system is mainly implemented in the form of a server computer, which provides a graphical user interface (GUI) to be accessed by potential buyers through the Internet, and accepts buyer input instructions. Buyers use computer devices to connect and request the system to provide information through the Internet, and can browse the information displayed by the system, including descriptions and quotations of products or services. The GUI also provides a way for the buyer to input instructions and data. Buyers can interact with the system by operating the keyboard, mouse, gestures or voice, input instructions and other data, browse or listen to the information provided by the system to complete the transaction.

According to a preferred embodiment of the present invention, the automated product/service vending system of the present invention comprises:

a product/service information management device, to store related information of at least one product or service, including name, description, list price, compensation value, inventory, checkout and shipping link etc. information;

an e-commerce device to connect the product/service information management device and the Internet, to provide a graphical user interface (GUI) to a client device when requested by the client device, and to exchange data with client device; wherein the GUI provides transaction-related information of a product or service, and wherein the e-commerce device is configured to completes at least one transaction of the product or service according to data input by the client device when operating the GUI; wherein the completion of a transaction comprises at least one of the following steps: proposing a discount price for the product/service, accepting a request and/or a response sent by the client device, responding to the request and/or response of the client device, providing a checkout link, and determine whether a checkout operation of a transaction is completed;

a price checking device connected to the product/service information management device and the Internet, to select, according a predetermined rule, a product or service which product or service-related information is stored in the product/service information management device and to connect via the Internet a plurality of website that offers or displays the selected product/service, to obtain at least one lowest market price of the product/service from among the plurality of website;

a customer identifying device connected to the product/service information management device, the e-commerce device and the Internet, and configured to connect a plurality of website through the Internet, to obtain representative data relating to at least one webpage that offers or displays the selected product/service, and/or a representative data of at least one webpage displaying information related to the selected product/service, in response to an instruction of the e-commerce device; the selected product/service being preferably one of the products or services which product or service-related information is stored in the product/service information management device, with an inventory greater than a predetermined quantity; the representative data being preferably a hyperlink; the at least one webpage preferably relating to one of a search engine, a social media, a news website, and an object browsing webpage, wherein information related to the selected product/service is displayed; and

a price generating device connected to the product/service information management device, the e-commerce device, the price checking device and the customer identifying device, and configured to calculate, based on the obtained lowest market price, a list price and a compensation value stored in the product/service information management device, a discount price comprising a price lower than a market price and while profitable, preferably lower than the lowest market price and while profitable, in response to an instruction of the e-commerce device;

wherein the e-commerce device is configured to from time to time instruct the price checking device to select a product/service from the products/services stored in the product/service information management device, to instruct the customer identifying device to obtain the representative data, and, in response to a representative data so obtained, to instruct the price checking device to obtain the lowest market price of the product or service, and to display the discount price generated by the price generating device on a webpage corresponding to the representative data, preferably as well as relative information of the product or service.

In some preferred embodiments of the present invention, the discount price is calculated as follows:

The discount price is a price lower than the lowest market price, and makes the list price−the discount price<the compensation value . . . (1)

In a specific embodiment, the discount price is calculated as follows:

The discount price is a price lower than the lowest market price by a predetermined value (the lowest market price−the discount price=a predetermined value), such that the list price−the discount price<the compensation value . . . (2) wherein, the predetermined value may be a set value or a percentage.

In a preferred embodiment of the present invention, the e-commerce device may also be configured to provide the graphical user interface when receiving a connection request from a client device; to search in the product/service information management device in response to an input of descriptive data by the client device in the graphic interface; to determine whether a product or service-related information corresponding to the descriptive data is stored in the product/service information management device; if yes, to instruct the price checking device to obtain a lowest market price of the product or service, to instruct the price generating device to calculate a discount price based on the lowest market price; and to display the discount price and/or product/service-relative information on the graphical user interface.

The e-commerce device of the present invention can be further configured to: when a plurality of list price and/or compensation value relating to the selected product/service is stored in the product/service information management device, instruct the price generating device to calculate a discount price for each list price or compensation value and select a most favored price and display the most favored price and related information of the selected product or service on the graphical user interface.

In a preferred embodiment of the present invention, the most favored price is selected in the following way:
1) A difference between the list price and the compensation value of each of the plurality of list price and compensation value is added by a least profit value to generate a candidate discount price and a most favored price is selected from the obtained candidate discount prices that are lower than the lowest market price; wherein the most favored price may be one of a highest candidate discount price and a lowest candidate discount price.
2) A difference between the list price and the compensation value of each of the plurality of list price and compensation value is calculated to select a least difference value; a second difference between the least difference value and the lowest market price is calculated; a discount price that is lower than the lowest market price by a predetermined value is used as the most favored price, if the second difference value is greater than a least profit value; otherwise, a difference between the list price and the compensation value is added by the least profit value, to generate the most favored price, if the obtained most favored price is lower or equal to the lowest market price; otherwise no most favored price is generated.

In a preferred embodiment of the present invention, the product or service-related information displayed on the graphical user interface by the e-commerce device comprises a predetermined quantity of lowest market price and descriptive information of corresponding providers.

The automated vending method for product and service of the present invention is used to perform quotation, checkout and arrange shipment in the invented automated product/service vending system.

The automated vending method for product and service according to the present invention comprises the following steps:
1. The e-commerce device selects a product/service which inventory is greater than a predetermined value in the product/service information management device; the selection can be random or according to a predetermined priority. Alternatively, the method may begin with the graphical user interface accepting user selection input of a product/service descriptive information.
2. The customer identifying device is connected to the Internet to obtain representative data of at least one webpage offering or displaying the selected product/service, and/or representative data of at least one webpage displaying information related to the selected product/service.
3. The price comparison device is connected to the Internet, searches for price information of the selected product/service provided in a webpage relating to the product/service and selects a lowest market price of the selected product/service.
4. The price generating device calculates a discount price of the product/service, wherein the discount price is calculated according to one of the calculation methods as described above.
5. The price generation device displays the generated discount price and corresponding product/service-related information on the graphic interface and requests an instruction of whether to purchase or not.
6. Upon receipt of an instruction to purchase, the checkout and shipping operations are executed.

According to a preferred embodiment of the present invention, when the selected product/service has a plurality of list price and/or compensation value stored in the product/service information management device, a most favored price may be determined in one of the following ways:
1) A difference between the list price and the compensation value of each of the plurality of list price and compensation value is added by a least profit value to generate a candidate discount price and a most favored price is selected from the obtained candidate discount prices that are lower than the lowest market price; wherein the most favored price may be one of a highest candidate discount price and a lowest candidate discount price.
2) A difference between the list price and the compensation value of each of the plurality of list price and compensation value is calculated to select a least difference value; a second difference between the least difference value and the lowest market price is calculated; a discount price that is lower than the lowest market price by a predetermined value is used as the most favored price, if the second difference value is greater than a least profit value; otherwise, a difference between the list price and the compensation value is added by the least profit value, to generate the most favored price, if the obtained most favored price is lower or equal to the lowest market price; otherwise no most favored price is generated.

The above and other objectives and advantages of the present invention can be more clearly illustrated by the following detailed description with reference to the accompanying drawings.

### BRIEF DESCRIPTION OF THE DRAWINGS

FIG. 1 shows a schematic diagram of the automated product/service vending system of the present invention.

FIG. 2 shows an example of a graphic user interface applicable to the automated product/service vending system of the present invention.

FIG. 3 shows a flow chart of an automated vending method for product/service suitable for the automated product/service vending system of the present invention.

### DETAILED DESCRIPTION OF THE INVENTION

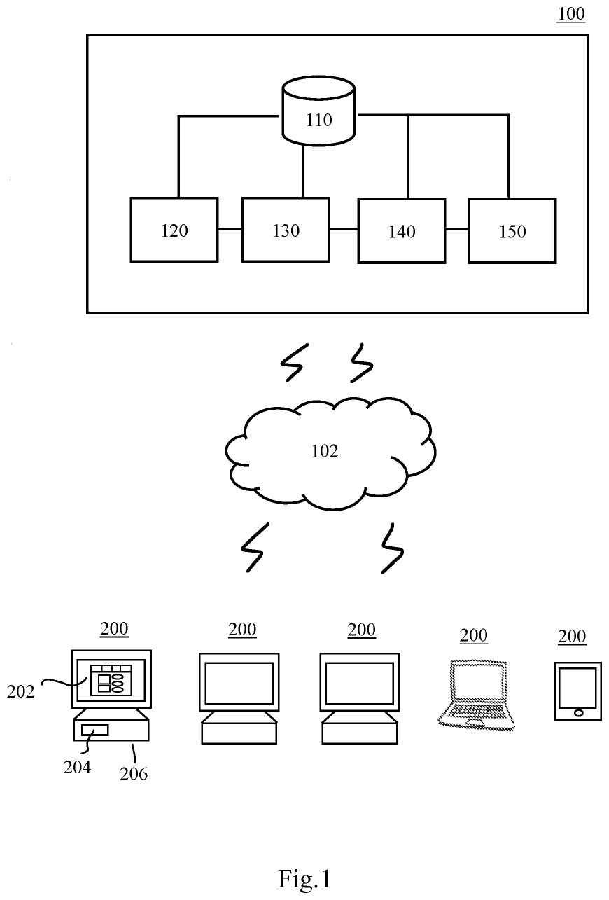

Please refer to FIG. 1, which is a schematic diagram of the automated product/service vending system of the present invention. In an exemplary embodiment of an Internet-based vending and/or payment system, the automated product/service vending system 100 of the present invention provides service functionality to one or more client devices 200 over the Internet 102 (or wide area network WAN). FIG. 1 shows a client web page 202 (e.g., a browser), an application 204, and a dedicated client 206, all executing on a client device 200. Examples of the client device 200 are not limited to the above, and may be any device based on personal computer, mobile device, tablet computer, and the like.

As shown in FIG. 1, in this preferred embodiment, the automated product/service vending system 100 of the present invention is built in a server computer, is equipped with necessary application programs and hardware, and comprises a product/service information management device 110, an e-commerce device 120, a price checking device 130, a customer identifying device 140, a price generating device 150 and other useful modules or components. All the above and other modules or components can be independent hardware devices or in the form of application software, built on the server computer and necessary accompanying devices to provide the required services.

The product/service information management device 110 is preferably a database and a database management system, for storing related information of various products or services. The stored information mainly relates to the product/services sold by the automated product/service vending system 100. Products and services suitable for e-commerce transaction are mainly standardized products, that is, products and services that can be identified and a decision whether to buy can be made, as long as their name, model and/or other identifiable features are known, without the need of further descriptions in their nature and quality, or the need of verifications in person. In terms of commodities, the products that may be offered by the automated product/service vending system 100 of the present invention may include various home appliances, 3C products, daily necessities, books, stationery, food, kitchen supplies, luxury commodity, vehicles, industrial raw materials, standard parts etc. In terms of services, it may include: hotel service, travel service, cleaning service, home care service, traveler service, financial service, transportation service etc. In addition, unique commodities, such as antiques, collectibles, artworks, second-hand items, etc., are not suitable for the present invention because there are no commonly accepted standards to compare their price. In the product/service information management device 110, necessary information of various products/services for purpose of transaction is stored. The information may include codes, names, descriptive information, list price, compensation value, inventory, checkout and shipping link information, etc. of the product/service, as well as other auxiliary information, such as expiration date, special care in use, applicable special legal regulations, etc.

Among the above and other necessary information, the list price may be a price charged by the corresponding product/service provider to the buyer. The compensation value may be the value of a compensation paid by the corresponding product/service provider to the operator of the automated product/service vending system 100, that is, the remuneration paid by the provider upon the successful sale of a product or service. According to the present invention, no matter what price a product/service is ultimately sold for, the amount of compensation paid by the product/service provider is the same. As for the difference between the actual purchase price/actual selling price and the list price, the operator of the automated product/service vending system 100 will pay it to the buyer.

Of course, the above rules are not any technical limitation. The system may also be so configured that the buyer pays the product/service provider with an actual purchase price/actual selling price calculated by the present invention (that is, the discount price, as detailed below), and the product/service provider then pays to the operator of the invented automated product/service vending system the compensation value, after deducting the difference of the list price and the discount price.

As for the checkout and shipping link information, it means a hyperlink provided by the invented automated product/service vending system that enables a client device 200 to link a website corresponding to a product/service already purchased, to close the transaction, pay the bill and arrange the shipment. Since the checkout and shipping link information is provided by the product/service information management device 110 of the present invention, when the buyer links to the corresponding website, certain identification information will also be provided to the website, so that the provider of the product/service knows whom to pay the compensation. In addition, in order to provide refunds to buyers, the product/service information management device 110 is preferably also provided with a membership database, wherein stored member information may include code, name, delivery address, billing address, telephone number, bank account number or electronic payment tool account number and other information of the members.

A product/service information management device 110 having the above technical features can be realized by those skilled in the art by using various known database and/or database management techniques with necessary modifications. Detailed description thereof is thus omitted.

The e-commerce device 120 is connected to the product/service information management device 110 and the Internet 102 and provides a graphical user interface 210 to be displayed on the client device 200 when requested by the client device 200. The e-commerce device 120 exchanges instructions and data with the client device 200. The graphical user interface 210 is provided with necessary fields, including a display field 211 to display transaction-related information of a specific product or service, and an input field 212 to accept input instruction/data from the client device 200, so to receive messages from the customer, including instructions, data, and so on.

The main function of the graphical user interface 210 is to show buyers certain description and brief introduction of specific products/services, as well as the discount price provided by the automated product/service vending system of the present invention, so as to encourage buyers to buy the corresponding products/services by operating the graphical user interface 210. After the buyer purchases, the graphical user interface 210 arranges the payment of the price and the shipment of the purchased product/service. That is, to close a transaction of a product/service, based on the instructions sent by the buyer when operating the graphical user interface. Therefore, the graphical user interface 210 may be configured to provide the following functions: displaying the price reduction information of a specific product/service, accepting the operation of the client device 200 on the graphical user interface 210, and recognizing the input data of the client device 200, including requests and/or responses, displaying a response and/or request in response to the request and/or response sent by the client device 200, displaying checkout and shipping links, identifying an instruction input by the buyer on the graphical user interface 210, and determining whether the checkout and shipment operation of a transaction is completed according to the operation of the buyer on the graphical user interface 210.

An e-commerce device 120 having the above-mentioned technical features can be realized by those skilled in the art by using various known web-based application-related technologies with necessary modifications. Details thereof is thus omitted.

The price checking device 130 is connected to the product/service information management device 110 and the Internet 102, and is configured to select a product or service which related information is stored in the product/service information management device 110 according to predetermined rules, and to connect via the Internet 102 to a plurality of vendor websites 171, 172, 173 that offer or display the selected product/service, to obtain at least one lowest market price of the selected product or service.

As a matter of fact, to obtain the information of at least one lowest market price by connecting a plurality of websites where specific products/services are offered or displayed via the Internet and comparing the list prices of the product/service provided in the plurality of websites, is already a known art. Price comparison websites or APP are popular. They use the above-mentioned price comparison technology to obtain various lowest market price information and list the obtained lowest prices, as well as corresponding product/service description on a graphical user interface for buyers' reference, selection, and even purchase. Products/services which lowest market price is provided in the price comparison websites include: hotels and various daily necessities. Relevant technical details are known to those skilled in the art and are omitted here. As for the number of the lowest market price to be displayed, it is not any technical limitation, as long as it can provide buyer useful reference. Some of the prices collected by the price comparison websites may be false; they are provided with the purpose of disrupting the market. However, because the mechanism of the present invention is mainly based on price comparison, in the invented price generating device 150 described below, basically the collected price is considered real price. Of course, a price verification device 130 can also be equipped with a verification mechanism to verify whether the prices proposed by various businesses are valid, during the price checking process, and to eliminate false prices.

As for the rules for selecting specific Products/services, it may be a random selection. However, in some embodiments, it is also possible to configure a system, so that it selects only one specific product/service, products/services of a specific grades, products/services supplied to specific regions, products/services supplied from specific countries/regions, etc., for special promotion activities. In other embodiments of the present invention, the price checking device 130 is configured to perform a price checking operation on the product/service in response to buyer input of related description information. For example, a Product Name field 212 is provided on the graphical user interface for the buyer to input descriptive information of the desired product/service. Another option is to provide hyperlinks on the product/service sales platform. As long as a user clicks, inputs, or otherwise expresses interest in a specific product/service, the user computer will be connected to the invented system, and the price checking device 130 will be activated for price checking.

A price checking device with the above-mentioned technical features can be realized by those skilled in the art by using various known web-based tools, data search tools, databases and/or database management techniques with necessary modifications. Details thereof are thus omitted.

The price checking device 130 may also performs price checking on websites that offer or display substitute/competitive products/services of the selected product/service. The substitute/competitive products/services corresponding to respectively products/services can be defined in advance and a list thereof is stored in the product/service information management device 110. Expanding the scope of search to include substitute/competitive products/services is a technology already known in the industry. For example, a system administrator can manually input the name and/or descriptive information of the substitute or competitive products/services when establishing an entry of a product/service item in the product/service information management device 110. In addition, in various fields of application, there already exist a variety of databases wherein corresponding relationship of substitutable product/services is defined. An example is the trademark commodity classification systems of various governments, which usually defines substitute products/services as a group. This and other similar group classification systems are also applicable to the present invention.

The customer identifying device 140 is connected to the product/service information management device 110 and the Internet 102, and is configured to connect to a plurality of websites via the Internet 102, to obtain representative data of at least one webpage offering or displaying the selected product/service, and/or or representative data of at least one web page displaying information related to the selected product/service. In practical application, the customer identifying device 140 preferably identifies a potential buyer in one of the following ways:

The first is to identify visitors to the website who are interested in purchasing a particular product or service. These visitors are usually the computer devices browsing web pages that offer or display the selected products/services. The customer identifying device 140 can obtain the representative data of the webpage, and operate to place an announcement of the discount price on the particular webpage, to catch the attention of the visitors.

The second is to identify visitors who intend to purchase a specific product or service from a group of visitors who link to a search engine, according to the behavior of the visitors. These visitors are typically the computer devices that are performing searches using the search engine, or are browsing the web pages that are related to the selected product/service, or are being input data that is relevant to the selected product/service. The customer identifying device 140 can obtain the representative data of the webpage, and operate to place the announcement of the discount price on the webpage.

The third method is to accept buyer active input of item information of a product or service. Such buyers can connect to the automated product/service vending system 100 with a computer, and input desired product/service descriptions in appropriate fields on the graphical user interface 210. The customer identifying device 140 can obtain the representative data from the graphical user interface 210 and place the advertisement of the discount price on the graphical user interface 210.

Methods other than the above can be applied to the present invention as long as the customer identifying device 140 can obtain useful webpage representative data that expresses interests in the selected products/services. Among the aforementioned methods, it is already a mature technology to identify visitors who intend to purchase specific products or services from among the group of visitors who is visiting a specific website. Patent No. TW I292107 “Webpage Advertising Method and System, and Agency Method for Webpage Advertising,” issued to the applicant discloses a method to determine a product/service that a webpage visitor intends to purchase, according to the behavior of the visitor, and to place an advertisement according to the determination. According to this Taiwan patent, the webpage advertising method includes the following steps:
(A) Receive behavioral information from a first web page displayed by a medium;
(B) Analyze contents of the first web page;
(C) Determine a set of advertising search criteria based on the analysis results;
(D) Calculate a similarity value of the advertising search criteria and the criteria value of an advertisement file in a database, and select the advertisement file with the highest similarity; and
(E) Display the advertisement file on the first web page.

The method disclosed in this Taiwan patent and other prior art methods for identifying a product or service that a visitor to a specific website intends to purchase can be applied to the present invention, with or without necessary modifications.

Advertisements displayed in this TW 1292107 patent can, with appropriate modification, function as useful quotation tools or transaction tools. The representative data used in the TW 1292107 patent can also be a hyperlink that can function as a link invitation. For example, by adding a link function to the advertisement page, the address and/or other representative data of the client device 200 can be retrieved, when the user clicks the advertisement page, and a communication channel can be established with the client device. A link function can also be added to the advertisement page to guide the client device 200 to connect a specific transaction website, to close a transaction.

In other embodiments of the present invention, the representative data includes link information that can be used to display specific message on the client device 200, such as an address that can receive a website link invitation, for display a discount price by the price generating device 150.

In addition, it is also a known technology to identify visitors who intend to purchase specific products or services from the visitors who link to a search website according to the behavior of the visitors. Those skilled in the art can use the existing technology to realize the customer identifying device 140 that provides the above-mentioned functions. The at least one webpage displaying information related to the selected product/service may be a search engine webpage, a social networking webpage, a news webpage, an object browsing webpage, etc. that provides useful consumer information and displays information related to the selected product/service. Collecting information that describes the behavior of visitors browsing such webpages, it is possible to use the artificial intelligence to identify products/services that visitors intend to buy.

Preferably before the customer identifying device 140 starts looking for customers, or at least before obtaining the representative data of a specific web page, it accesses the product/service information management device 110 to confirm that the related information of the selected product/service is stored in the product/service information management device 110, and the inventory is greater than a predetermined value. However, this approach is not any technical limitation, because the main purpose is to avoid paying useless advertising media costs. In terms of application, usually the e-commerce device 120 can search in the product/service information management device 110 for a product/service suitable for offering a discount price, before it instructs the customer identifying device 140 to perform operations.

The price generating device 150 is connected to the product/service information management device 110, the e-commerce device 120, the price checking device 130, and the customer identifying device 140, and is configured to calculate a discount price that is attractive to the consumers identified by the customer identifying device 140, in response to the instructions of the e-commerce device 120. The discount price is generated based on the lowest market price obtained by the price checking device 130 and the list price and the compensation value stored in the product/service information management device 110. The discount price so calculated would be highly attractive to the customers identified by the customer identifying device 140. According to the present invention, the discount price may be a price that is lower than the general market price but is profitable, especially a price that is lower than the known lowest market price and can be profitable.

In some preferred embodiments of the present invention, the discount price is calculated as follows:

The discount price is a price lower than the lowest market price, and satisfies the list price−the discount price<the compensation value . . . (1)

In a specific embodiment, the discount price is calculated as follows:

The discount price is a price lower than the lowest market price by a predetermined value (the lowest market price−the discount price=a predetermined value), such that the list price−the discount price<the compensation value . . . (2)

wherein, the predetermined value may be a set value or percentage.

The discount price offered by the present invention would be lower than the lowest market price of the same product/service and/or its substitute product/services, it will be extremely attractive to the identified customers. In addition, as a result of selling at the discount price, the operator of the automated product/service vending system 100 can still retain part of the compensation, which could be higher than the least profit value. The results satisfy the interests of the operator. It can be described as a win-win game.

A price generating device 150 with the above-mentioned technical features can be realized by professionals in this industry after making necessary modifications to the general-purpose computer device according to the above-mentioned or other calculation formulas. It can also be implemented in the computer device in the form of application software to provide the functions required by the price generating device 150. In a preferred embodiment of the present invention, the e-commerce device 120 is configured to instruct the customer identifying device 140 to perform the customer identification operation, and after the customer identifying device 140 generates the webpage representative data, instruct the price checking device 130 to search for the lowest market price of the product or service corresponding to the representative data, and instructs the price generating device 150 to calculate the discount price based on the obtain lowest market price, and publish the discount price information preferably the discount price and related information of the corresponding product/service, on the webpage corresponding to the representative data.

In a preferred embodiment of the present invention, the e-commerce device 120 can also be configured to provide the graphical user interface 210 when receiving a connection request from the client device 200, on the client device 200, and, after a user operates on the graphical user interface 210 and inputs the descriptive information of a selected product or service, access the product/service information management device 110, and, when it is determined that the selected product or service is an item stored in the product/service information management device 110, instruct the price checking device 130 to search for a lowest market price of the product/service, and instruct the price generating device 150 to calculate the discount price based on the lowest market price, them display the discount price, preferably the discount price and related information of the corresponding product/service, on the graphical user interface.

In the aforementioned embodiment, the e-commerce device 120 can also be configured to display a website link invitation on the graphical user interface, after the discount price is generated, and display the discount price and relative information of the product or services corresponding to the discount price on the graphical user interface.

The e-commerce device 120 of the present invention can be further configured to: when it determines that more than one list price and/or compensation value for the selected product/service is stored in the product/service information management device 110, instruct the price generating device 150 to calculate a discount price for each list price and/or compensation value, and select a most favored price among the generated discount prices, and display the most favored price and related information of the corresponding product or service on the webpage.

In a preferred embodiment of the present invention, the most favored price may be selected in the following way:
1) A difference between the list price and the compensation value of each of the plurality of list price and compensation value is added by a least profit value to generate a candidate discount price and a most favored price is selected from the obtained candidate discount prices that are lower than the lowest market price; wherein the most favored price may be one of a highest candidate discount price and a lowest candidate discount price.
2) A difference between the list price and the compensation value of each of the plurality of list price and compensation value is calculated to select a least difference value; a second difference between the least difference value and the lowest market price is calculated; a discount price that is lower than the lowest market price by a predetermined value is used as the most favored price, if the second difference value is greater than a least profit value; otherwise, a difference between the list price and the compensation value is added by the least profit value, to generate the most favored price, if the obtained most favored price is lower or equal to the lowest market price; otherwise no most favored price is generated.

In a preferred embodiment of the present invention, the product or service-related information displayed on the graphic interface by the e-commerce device 120 may also include a predetermined number of lowest market price and its provider's description information.

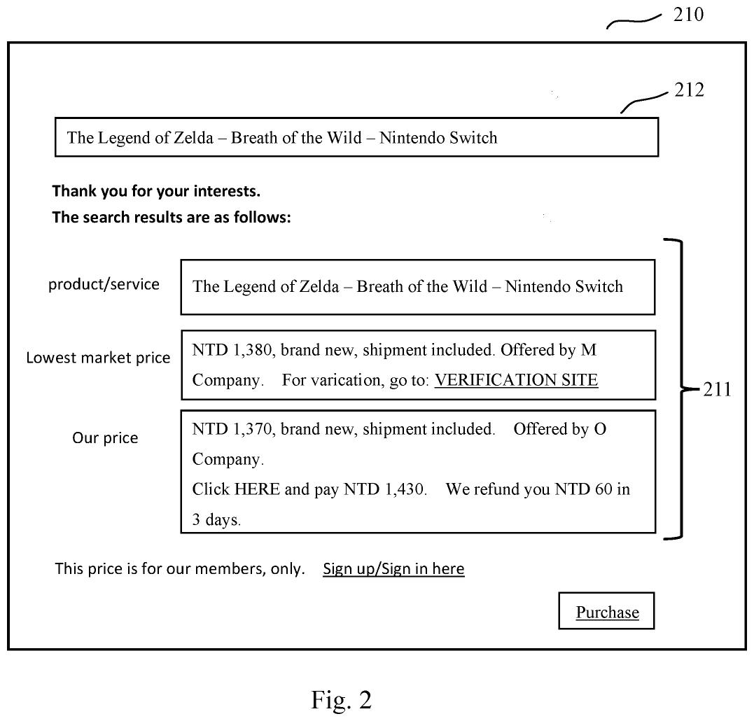

An example of a graphical user interface 210 useful in the automated product/service vending system of the present invention is shown in FIG. 2. The format, display items, display content and display method of the graphical user interface 210, will be described in the followings, accompanied with the description of the automated product/service vending method of the present invention.

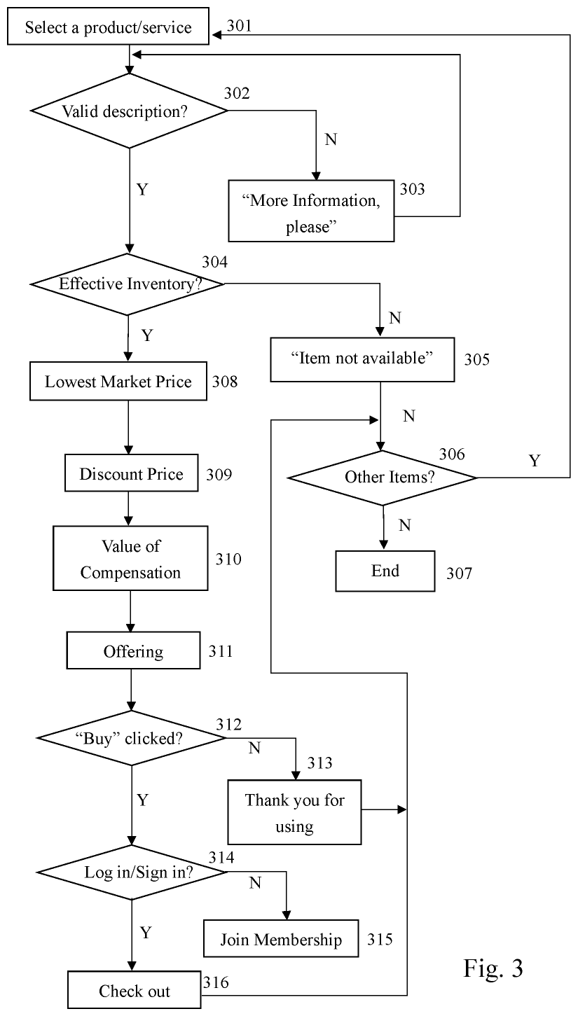

At first, the automated product/service vending method, used in the automated product/service vending system of the present invention will be described with reference to FIG. 3, which is a flow chart of the invented automated product/service vending method.

As shown in the figure, in step 301, a buyer inputs identification information related to a product the buyer wants to purchase in the “Product Name” field 212 of the graphical user interface 210, such as a browser search webpage. According to the present invention, the identification information input on the input page is preferably information that can be used to specify the product/service. As mentioned earlier, the main purpose of the present invention is to buy/sell products/services with standard specifications. Examples of a product/service with standard specifications include products of a specific brand and/or model, and services provided by specific service providers and/or of a specific level. For example, iPhone 12, The Legend of Zelda-Breath of the Wild, Nintendo Switch. They are all valid descriptions for products with standard specifications. Business floor rooms at The Regency Taipei Hotel for Sep. 23-27, 2021, and Eva Air Taipei-San Francisco business class ticket, they are all valid descriptions of services with standard specifications.

A valid description of products and services with standard specifications is helpful in providing sufficient information for searching and comparing prices. The level of detail that should be described can be set by the system designer when the product is put on the shelves.

In step 302, the system determines whether the data input by the buyer is sufficient for completing a transaction according to the default description format, preferably a format set when the product is put on the shelves. If the determination result is negative, then in step 303 a warning message is generated to remind the buyer to input required data. If the determination result is yes, the system searches in the product/service information management device 110 in step 304, to determine whether the item corresponding to the input identification information is in stock, available for sale and/or the quantity is sufficient. That is, the system determines whether there is valid stock or not. If the determination result is negative, then in step 305, a warning message is generated to inform the buyer that the product/service cannot be supplied, and the step will go to 306 to invite the buyer to input the identification information of another product/service. If the user clicks “no need,” the step goes to 307 to end the operation. If the buyer clicks “yes,” the step returns to step 301 and wait for further input by the buyer.

If the determination result of step 304 is yes, then in step 308 the price checking device 130 is connected to the Internet 102, to search for the lowest market price of the selected item in the online market, using the product/service identification information input in step 301 and/or stored the product/service-related information in the product/service information management device 110. In practice, it is possible to use a search software application to select the items with the lowest price from the openly offered prices of major suppliers, and use this price as the lowest market price.

In application, a predetermined number of lowest market prices can be selected and their prices and dealer information are obtained. For example, 3 lowest market prices can be selected. Taking several lowest market prices is helpful for normalizing the value of the lowest market price. For example, if a dealer maliciously sets an unreasonable price to disrupts the market, it can be corrected, when a number of lowest market prices is selected. In addition, providing multiple lowest market prices also gives the buyer useful reference information.

Next, in step 309, the list price of the selected product/service that has a valid stock (available for shipment) is retrieved from the product/service database of the product/service information management device 110, and a discount price is calculated. The discount price is preferably a profit-making price below the market price, especially a profit-making price below the lowest known market price:

Method 1. The discount price can be the following discount price 1:

Discount price 1=list price−compensation value+predetermined profit value, whereby

Discount price 1<the lowest market price (3)

If the predetermined profit value is a ratio, such as a certain percentage of the list price or the purchase cost of the product/service, the value of the compensation needs to be calculated first in step 310, then the discount price is calculated according to the aforementioned formulas.

When a plurality of discount prices that are lower than the lowest market price is generated, the price generating device 150 may select the highest discount price as the “most favored price” to offer, because the highest discount price can increase the profit. In this case, the item corresponding to this discount price would be the object of the transaction. Therefore, according to the design of the present invention, the generated discount price may not be the lowest discount price among them.

In other embodiments of the present invention, the discount price is not calculated according to formula (3). In this embodiment, after the discount price is calculated in step 310, the difference between the discount price and the lowest market price is compared with a predetermined value (“fair price difference”), and the discount price will be the result of the lowest market price minus the fair price difference. Therefore,

Method 2. The discount price is the discount price 2, as follows:

Discount price 2=lowest market price-fair price difference, if!lowest market price-discount price!≥fair price difference (4)

The method for selecting the most favored price according to the present invention is certainly not limited to the above. Generally speaking, as long as a price is lower than the lowest market price, and by selling the product/service, at least a part of the compensation value can be obtained. Of course, when selecting or calculating the most favored price, the amount of compensation retained after the transaction will be one of the most important considerations.

To take the most extreme example, if the search results find that one or more list price of the selected products/services stored in the product/service information management device 110 with effective inventory is already lower than the lowest market price, the price generating device 150 can select the list price of the item with the highest compensation value as the most favored price. Even if there are other items whose list price is higher than the lowest market price, which may result in a higher compensation value, selling directly the item at the list price can avoid the trouble of paying rebates to buyers. Cost savings may more than make up for the lost compensation.

In such an embodiment, the buyer may agree to buy, even if the actual selling price is the same as the lowest market price. This happens, especially when the buyer is a member and is entitled to a membership reword in response to a successful buy. Therefore, the actual selling price does not necessarily need to be lower than the lowest market price.

In addition, according to the present invention, if a buyer purchases the product/service corresponding to the discount price, the system may collect the buyer's payment in two ways:

The first is to charge that discount price. In this example, the system instructs the supplier to ship the product/service, and pays the difference between the list price and the compensation value to the supplier.

Another way is to redirect the buyer to the supplier's website, order the product from the supplier, and pay the list price. After completing the transaction, the supplier pays the compensation value to the operator of the system of the present invention, which then returns the difference between the list price and the discount price to the buyer.

In any case, the buyer purchases the product/service at the discount price. Only in the second application case shall the buyer be a member, in order to enjoy the rebate. In any case, the discount price will be lower than the lowest market price.

In step 311, the product/service information is displayed, that is, the name of the product/service selected by the calculation result, as well as related information, including the discount price, are displayed on the related webpage or the graphical user interface 210. An example of the graphic interface is shown in FIG. 2. In the graphical user interface 210, a buyer has input in the Product Name field 212 identification information (name) of the product/service that the buyer wishes to buy: “The Legend of Zelda—Breath of the Wild—Nintendo Switch,” for conducting a search. After search by the present invention, the following message is displayed in the display column 211 of the graphical user interface 210:

“Thank you for your interests. The search results are as follows:
1. Search for products/services: The Legend of Zelda—Breath of the Wild—Nintendo Switch
2. The lowest market price: NTD 1,380, brand new, shipment included. Offered by M Company.
   For varication, go to: VERIFICATION SITE (hyperlinks provided).
3. Our price: NTD 1,370, brand new, shipment included. Offered by O Company.
   Click HERE (hyperlink provided) and pay NTD 1,430. We refund you NTD 60 in 3 days.
4. This price is for our members, only. Sign up/Sign in here (hyperlink provided).”

In step 312, the system determines whether the buyer clicks on the purchase option. If the buyer does not click within a time limit, a warning message “Thank you for using” is displayed in step 313. The step goes to 306, where the user is asked whether to search for other products/services. If the user clicks on the purchase option, then in step 314 it is determined whether the user is a member. If not, go to step 315 to guide the buyer to obtain a membership. Thereafter, the checkout procedure is executed in step 316, followed by returning the step to 306, to ask whether the buyer wants to search other products/services. In addition, if the result of step 314 is yes, the step jumps to 316, to perform the checkout procedure. After completing the payment, the step goes to 306, to ask whether the user needs to search other products/services.

As described above, the present invention provides a novel automated product/service vending system and a product and service vending method applicable to the system. The system can automatically search for customers on e-commerce sites, search engine, social media sites and information sites, and initialize automated product/service vending operations. The invented system can also initialize its price offering operations in response to the user's request. The system and method of the present invention can provide a discount price which is lower than the market price, especially lower than the lowest known market price, and which can make the system operator profitable. The system may actively find buyers who are interested in purchasing specific products/services without requiring buyers to actively inquire. In addition, buyers do not need to actively offer a discount; the system will actively provide discount prices that are lower than the market price. This invention makes both buyers and sellers benefit from each other.

What is claimed is:

1. An automated product/service vending system, comprising:
a product/service information management device, to store related information of at least one product or service, including name, description, list price, compensation value, inventory, checkout and shipping link etc. information;
an e-commerce device to connect the product/service information management device and the Internet, to provide a graphical user interface (GUI) to a client device and to exchange data with client device;
wherein the GUI provides transaction-related information of a product or service, and wherein the e-commerce device is configured to completes at least one transaction of the product or service according to data input by the client device when operating the GUI;
a price checking device connected to the product/service information management device and the Internet, to select, according a predetermined rule, a product/service which product or service-related information is stored in the product/service information management device and to connect via the Internet a plurality of website that offers or displays the selected product/service, to obtain at least one lowest market price of the selected product/service from among the plurality of website;
a customer identifying device connected to the product/service information management device, the e-commerce device and the Internet, and configured to connect a plurality of website through the Internet, to obtain representative data relating to at least one webpage that offers or displays the selected product/service, and/or a representative data of at least one webpage displaying information related to the selected product/service;
a price generating device connected to the product/service information management device, the e-commerce device, the price checking device and the customer identifying device, and configured to calculate a discount price, based on the obtained lowest market price, and a list price and a compensation value stored in the product/service information management device, wherein the discount price comprises a price lower than the lowest market price and profitable, in response to an instruction of the e-commerce device;
wherein the e-commerce device is configured to from time to time instruct the price checking device to select a product/service from the products/services stored in the product/service information management device and to instruct the customer identifying device to obtain the representative data, and, in response to a representative data so obtained, to instruct the price checking device to obtain the lowest market price of the selected product or service, to instruct the price generating device to generate a discount price, and to display the discount price generated by the price generating device on a webpage corresponding to the representative data, preferably as well as relative information of the product or service.

2. The system according to claim 1, wherein completing a transaction comprises the following steps:
offering a discount price for a specific product/service, accepting a client device request and/or response, providing a respond and/or request in response to the request and/or response of the client device, providing a checkout/shipping link, and determining whether the checkout/shipping operation of a single transaction has been completed.

3. The system according to claim 1, wherein the selected product/service comprises a product/service which product or service-related information is stored in the product/service information management device and which inventory is greater than a predetermined value.

4. The system according to claim 1, wherein the representative data comprise an address information to which a website link invitation may be sent to.

5. The system according to claim 1, wherein the at least one webpage displaying the product or service-related information comprises one selected from the group consisted of search engine webpage, social networking webpage, news webpage, and object browsing webpage.

6. The system according to claim 1, wherein the discount price is calculated as follows:
the discount price is a price lower than the lowest market price, such that
the list price−the discount price<the compensation value.

7. The system according to claim 1, wherein the discount price is calculated as follows:
the discount price is a price lower than the lowest market price by a predetermined value (the lowest market price−the discount price=a predetermined value), such that
the list price−the discount price<the compensation value;
wherein, the predetermined value is a set value or a percentage.

8. The system according to claim 1, wherein the e-commerce device is further configured to: when a plurality of list price and/or compensation value relating to the selected product/service is stored in the product/service information management device, instruct the price generating device to calculate a discount price for each list price or compensation value and select a most favored price and display the most favored price and related information of the selected product or service on the GUI.

9. The system according to claim 8, wherein the most favored price is determined as follows:
a difference between the list price and the compensation value of each of the plurality of list price and compensation value is added by a least profit value to generate a candidate discount price and a most favored price is selected from the obtained candidate discount prices that are lower than the lowest market price; wherein the most favored price is one of a highest candidate discount price and a lowest candidate discount price

10. The system according to claim 8, wherein the most favored price is determined as follows:
a difference between the list price and the compensation value of each of the plurality of list price and compensation value is calculated to select a least difference value; a second difference between the least difference and the lowest market price is calculated; a discount price that is lower than the lowest market price by a predetermined value is used as the most favored price, if the second difference value is greater than a least profit value; otherwise, a difference between the list price and the compensation value is added by the least profit value, to generate the most favored price, if the obtained most favored price is lower or equal to the lowest market price; otherwise no most favored price is generated.

11. The system according to claim 6, wherein the e-commerce device is configured:
to provide the GUI when receiving a connection request from a client device; to search in the product/service information management device in response to an input of a descriptive information of a selected product/service by the client device in the GUI; to determine whether a product or service-related information corresponding to the descriptive information is stored in the product/service information management device; if yes, to instruct the price checking device to obtain a lowest market price of the selected product/service, to instruct the price generating device to generate a discount price based on the obtained lowest market price; and to display the discount price and/or relative information of the selected product/service on the GUI.

12. The system according to claim 11, wherein the e-commerce device is further configured to: when a plurality of list price and/or compensation value relating to the selected product/service is stored in the product/service information management device, instruct the price generating device to calculate a discount price for each list price or compensation value and select a most favored price and display the most favored price and related information of the selected product/service on the GUI.

13. The system according to claim 12, wherein the most favored price is determined as follows:
a difference between the list price and the compensation value of each of the plurality of list price and compensation value is calculated; the difference is added by a least profit value to generate a candidate discount price and a most favored price is selected from the obtained candidate discount prices that are lower than the lowest market price; wherein the most favored price is one of a highest candidate discount price and a lowest candidate discount price

14. The system according to claim 12, wherein the most favored price is determined as follows:
a difference between the list price and the compensation value of each of the plurality of list price and compensation value is calculated to select a least difference value; a second difference between the least difference and the lowest market price is calculated; a discount price that is lower than the lowest market price by a predetermined value is used as the most favored price, if the second difference value is greater than a least profit value; otherwise, a difference between the list price and the compensation value is added by the least profit value, to generate the most favored price, if the obtained most favored price is lower or equal to the lowest market price; otherwise no most favored price is generated.

15. The system according to claim 7, wherein the e-commerce device is configured: to provide the GUI when receiving a connection request from a client device; to search in the product/service information management device in response to an input of a descriptive information of a selected product/service by the client device in the GUI; to determine whether a product or service-related information corresponding to the descriptive information is stored in the product/service information management device; if yes, to instruct the price checking device to obtain a lowest market price of the selected product/service, to instruct the price generating device to generate a discount price based on the obtained lowest market price; and to display the discount price and/or relative information of the selected product/service on the GUI.

16. The system according to claim 15, wherein the e-commerce device is further configured to: when a plurality of list price and/or compensation value relating to the selected product/service is stored in the product/service information management device, instruct the price generating device to calculate a discount price for each list price or compensation value and select a most favored price and display the most favored price and related information of the selected product/service on the GUI.

17. The system according to claim 14, wherein the most favored price is determined as follows:
a difference between the list price and the compensation value of each of the plurality of list price and compensation value is calculated; the difference is added by a least profit value to generate a candidate discount price and a most favored price is selected from the obtained candidate discount prices that are lower than the lowest market price; wherein the most favored price is one of a highest candidate discount price and a lowest candidate discount price

18. The system according to claim 14, wherein the most favored price is determined as follows:
a difference between the list price and the compensation value of each of the plurality of list price and compensation value is calculated to select a least difference value; a second difference between the least difference and the lowest market price is calculated; a discount price that is lower than the lowest market price by a predetermined value is used as the most favored price, if the second difference value is greater than a least profit value; otherwise, a difference between the list price and the compensation value is added by the least profit value, to generate the most favored price, if the obtained most favored price is lower or equal to the lowest market price; otherwise no most favored price is generated.

19. The system according to claim 1, wherein the product or service-related information displayed on the GUI by the e-commerce device comprises a predetermined quantity of lowest market price and descriptive information of corresponding providers.

20. The system according to claim 19, wherein the product or service-related information displayed on the GUI by the e-commerce device comprises a predetermined quantity of lowest market price and descriptive information of corresponding providers.

21. An automated product/service vending system, comprising:
a product/service information management device, to store related information of at least one product or service, including name, description, list price, compensation value, inventory, checkout and shipping link etc. information;
an e-commerce device to connect the product/service information management device and the Internet, to provide a graphical user interface (GUI) to a client device when requested by the client device, and to exchange data with client device;
wherein the GUI provides transaction-related information of a product or service, and wherein the e-commerce device is configured to completes at least one transaction of the product or service according to data input by the client device when operating the GUI;
a price checking device connected to the product/service information management device and the Internet, to select, according a predetermined rule, a product/service which product or service-related information is stored in the product/service information management device and to connect via the Internet a plurality of website that offers or displays the selected product/service, to obtain at least one lowest market price of the selected product/service from among the plurality of website;
a customer identifying device connected to the product/service information management device, the e-commerce device and the Internet, and configured to connect a plurality of website through the Internet, to obtain representative data relating to at least one webpage that offers or displays the selected product/service, and/or a representative data of at least one webpage displaying information related to the selected product/service;
a price generating device connected to the product/service information management device, the e-commerce device, the price checking device and the customer identifying device, and configured to calculate a discount price, based on the obtained lowest market price, and a list price and a compensation value stored in the product/service information management device, wherein the discount price comprises a price lower than the lowest market price and profitable, in response to an instruction of the e-commerce device;
wherein the e-commerce device is configured: to provide the GUI when receiving a connection request from a client device; to search in the product/service information management device in response to an input of a descriptive information of a selected product/service by the client device in the GUI to determine whether a product or service-related information corresponding to the descriptive information is stored in the product/service information management device; if yes, to instruct the price checking device to obtain a lowest market price of the selected product or service, to instruct the price generating device to generate a discount price based on the obtained lowest market price; and to display the discount price and/or relative information of the selected product or service on the GUI.

22. The system according to claim 21, wherein the e-commerce device is further configured to: when a plurality of list price and/or compensation value relating to the selected product/service is stored in the product/service information management device, instruct the price generating device to calculate a discount price for each list price or compensation value and select a most favored price and display the most favored price and related information of the selected product/service on the GUI.

23. The system according to claim 22, wherein the most favored price is determined as follows:
a difference between the list price and the compensation value of each of the plurality of list price and compensation value is added by a least profit value to generate a candidate discount price and a most favored price is selected from the obtained candidate discount prices that are lower than the lowest market price; wherein the most favored price is one of a highest candidate discount price and a lowest candidate discount price

24. The system according to claim 22, wherein the most favored price is determined as follows:
a difference between the list price and the compensation value of each of the plurality of list price and compensation value is calculated to select a least difference value; a second difference between the least difference and the lowest market price is calculated; a discount price that is lower than the lowest market price by a predetermined value is used as the most favored price, if the second difference value is greater than a least profit value; otherwise, a difference between the list price and the compensation value is added by the least profit value, to generate the most favored price, if the obtained most favored price is lower or equal to the lowest market price; otherwise no most favored price is generated.

25. The system according to claim 21, wherein the discount price is calculated as follows:
the discount price is a price lower than the lowest market price, such that the list price−the discount price<the compensation value.

26. The system according to claim 17, wherein the discount price is calculated as follows:
the discount price is a price lower than the lowest market price by a predetermined value (the lowest market price−the discount price=a predetermined value), such that the list price−the discount price<the compensation value;
wherein, the predetermined value is a set value or a percentage.

27. An automated product and service vending method for execution in an automated product/service vending system comprising:
a product/service information management device, to store related information of at least one product or service, including name, description, list price, compensation value, inventory, checkout and shipping link etc. information;
an e-commerce device to connect the product/service information management device and the Internet, to provide a graphical user interface (GUI) to a client device when requested by the client device, and to exchange data with client device;
wherein the GUI provides transaction-related information of a product or service, and wherein the e-commerce device is configured to completes at least one transaction of the product or service according to data input by the client device when operating the GUI;
a price checking device connected to the product/service information management device and the Internet, to select, according a predetermined rule, a product or service which product or service-related information is stored in the product/service information management device and to connect via the Internet a plurality of website that offers or displays the selected product/service, to obtain at least one lowest market price of the selected product/service from among the plurality of website;
a customer identifying device connected to the product/service information management device, the e-commerce device and the Internet, and configured to connect a plurality of website through the Internet, to obtain representative data relating to at least one webpage that offers or displays the selected product/service, and/or a representative data of at least one webpage displaying information related to the selected product/service;
a price generating device connected to the product/service information management device, the e-commerce device, the price checking device and the customer identifying device, and configured to calculate a discount price, based on the obtained lowest market price, and a list price and a compensation value stored in the product/service information management device, wherein the discount price comprises a price lower than the lowest market price and profitable, in response to an instruction of the e-commerce device;
the method comprising the following steps:
the e-commerce device instructs the price checking device to selects a product/service whose inventory is greater than a predetermined value in the product/service information management device;
the customer identifying device is connected to the Internet to obtain representative data of at least one webpage offering or displaying the selected product/service, and/or representative data of at least one webpage displaying information related to the selected product/service;
the price comparison device is connected to the Internet, searches for price information of the selected product/service provided in a webpage relating to the selected product/service and selects a lowest market price of the selected product/service;
the price generating device calculates a discount price for the selected product/service;
the price generation device displays the obtained discount price and corresponding product/service-related information on the GUI and requests an instruction of whether to purchase or not; and
upon receipt of an instruction to purchase, the checkout and shipping operations are executed;
wherein the discount price is determined in one of the following ways:
the discount price is a price lower than the lowest market price, and makes the list price−the discount price<the compensation value; or
the discount price is a price lower than the lowest market price by a predetermined value (the lowest market price−the discount price=a predetermined value), so that the list price−the discount price<the compensation value;
wherein, the predetermined value is a set value or a percentage.

28. The method according to claim 27, wherein the product/service is selected randomly or according to a predetermined priority in the product/service information management device.

29. The method according to claim 27, wherein the selected product/service is a product/service which descriptive information is input in the GUI by a client device.

30. The method according to claim 27, further comprising the steps of: when a plurality of list price and/or compensation value relating to the selected product/service is stored in the product/service information management device, calculating a discount price for each list price or compensation value and selecting a most favored price and displaying the most favored price and related information of the selected product/service on the GUI.

31. The method according to claim 30, wherein the most favored price is determined as follows:
a difference between the list price and the compensation value of each of the plurality of list price and compensation value is calculated; the difference is added by a least profit value to generate a candidate discount price and a most favored price is selected from the obtained candidate discount prices that are lower than the lowest market price; wherein the most favored price may be one of a highest candidate discount price and a lowest candidate discount price.

32. The method according to claim 30, wherein the most favored price is determined as follows:
a difference between the list price and the compensation value of each of the plurality of list price and compensation value is calculated to select a least difference value; a second difference between the least difference and the lowest market price is calculated; a discount price that is lower than the lowest market price by a predetermined value is used as the most favored price, if the second difference value is greater than a least profit value; otherwise, a difference between the list price and the compensation value is added by the least profit value, to generate the most favored price, if the obtained most favored price is lower or equal to the lowest market price; otherwise no most favored price is generated.
